(19) United States
(12) Patent Application Publication
(10) Pub. No.: US 2014/0220212 A1
(43) Pub. Date: Aug. 7, 2014

(54) Apparatus and Method for Cooking Food Using Fire Searing

(71) Applicant: Gino Scotto, Westbury, NY (US)

(72) Inventor: Gino Scotto, Westbury, NY (US)

(21) Appl. No.: 14/169,168

(22) Filed: Jan. 31, 2014

Related U.S. Application Data
(60) Provisional application No. 61/758,792, filed on Jan. 31, 2013.

(51) Int. Cl. A47J 37/06; A23L 1/01

(52) U.S. Cl. CPC A47J 37/0694; A23L 1/0128
USPC 426/523; 99/443 R

(57) ABSTRACT

The present invention is an apparatus/device that can be used inside certain existing open ovens to retrofit them for use of the novel method of cooking discovered by applicant. The present invention is also a new and improved open oven that enables the invented method of cooking disclosed herein.

### CROSS-REFERENCE TO RELATED APPLICATION

This application claims the benefit of, U.S. Provisional Application Ser. No. 61/758,792 filed on Jan. 31, 2013 which is expressly incorporated herein in its entirety by reference thereto.

### FIELD OF THE INVENTION

The present invention relates to cooking methods and procedures and the machinery and tools used to cook food. More specifically, the present invention relates to a novel process for cooking meats, seafood, poultry as well as foods from other food groups, using a direct flame and a unique cooking procedure and apparatus to fire sear the food.

### BACKGROUND OF THE INVENTION

Food processing and the commercial sale of cooked foods is a multi-billion dollar industry. Consumers revisit restaurants and food processing companies largely because of a reputation for providing favorable tasting, high quality foods. However, consumers often purchase and consume foods with little or no knowledge as to the process(es) used to prepare and cook the food.

Conventional and modern day methods of cooking raw foods include common heating elements in an open or closed heating system, e.g., a barbeque grill, a stove top, and a closed oven, using gas fired heat, wood fired heat, or electric heat. In a commercial kitchen, for example, cooking professionals and chefs, typically use steel ovens and open range ovens for the majority of the cooking. Known methods of cooking steak, beef, lamb, pork, veal and/or any other mammalian game have included using a broiler, a pan or cooking the meats on an open grill, such as a barbeque grill. In some instances for specific foods, such as for pizza, the food is cooked using an indirect cooking method (the heat source is placed to the side of the food, not directly under it) such as open brick ovens or hearth ovens. An open brick oven or a hearth oven is also sometimes used in and around outdoor patios for outdoor cooking. In an open brick oven and hearth oven, the heat source (e.g., wood) for the oven is located on the side away from the cooking area. The heat source raises the temperature in the oven to the desired temperature, usually between 350° and 500° Fahrenheit, not more than about 700° Fahrenheit although the materials of construction for most open ovens (e.g, brick, clay, stone) allow for much greater temperatures inside the ovens.

Particularly in North America, other than for cooking pizza and breads, wood burning ovens are not used for cooking meats, seafood, poultry and other foods due, at least in part, to the unfavorable conventional flat slab cooking surface in a brick oven or hearth oven, the inability to control liquid and juice runoff in an open oven, the difficulty with cooking on a substantially flat surface and using indirect heat, the lack of proper equipment for cooking in such an apparatus, and the increased time to cook as compared to using other cooking equipment.

Normal cooking temperatures in ovens and grills for meats are typically between 200° and 700° Fahrenheit. Recommended cooking temperatures for meats typically range anywhere from 300° to 550° Fahrenheit.

### SUMMARY OF THE INVENTION

The present invention improves the quality, taste and visual delivery of finished food stocks and provisions by cooking them at higher temperatures than traditional methods, for shorter periods of time, and in a direct flame.

For a better understanding of the invention, its operating advantages and the specific objects attained by its uses, reference should be made to the accompanying drawings annexed hereto to and forming a part of this disclosure and descriptive matter in which there are illustrated preferred embodiments of the invention.

The preparation and cooking of meats, seafood, poultry and food from other food groups (“food stocks and provisions”) requires numerous labor intensive steps, heating and/or cooling methods, as well as a period of time to prepare completed and finished cooked foods.

The present invention is an apparatus/device that can be used inside certain existing open ovens to retrofit them for use of the novel method of cooking discovered by applicant. The present invention is also a new and improved open oven that enables the invented method of cooking disclosed herein.

The present invention includes a new and novel method of preparing food stocks and provisions by placing them directly into a flame (“Fire Source”) at much higher cooking temperatures than presently used. The method according to the present invention utilizes temperatures greater than at least 700° Fahrenheit, preferably greater than 1000° F. These higher than normal temperatures require new, specialized equipment capable of withstanding the temperatures and also capable of being handled and utilized by the cooking personnel without injury. Terms that may be used to describe the cooking method according to the invention include “Fire Searing,” “Flame Quenching,” and “In-Fire Cooking.”

The novelty of the method of cooking according to the present invention includes direct cooking and searing the food at a high temperature for a short period of time in an open oven. The high temperatures attainable and sustainable in an open oven, but not currently utilized by known cooking methods, due to an open oven's materials of construction and generally dome like configuration are ideal for the method of cooking according to the invention. The high temperatures desired for the method of cooking according to the invention will not cause damage to the cooking structure. With certain modifications and new equipment to create a more desirable cooking surface and/or deck, to collect liquid runoff, to enable manipulation of the food during cooking, and for safe cooking without injury, an open oven configuration is desired. The apparatus/device for retrofitting existing commercial open brick ovens and/or hearths are part of applicant's invention. The improved taste and texture of food cooked according to the method of the current invention using direct flame and high temperatures for short periods of cooking time are favorable and desired.

The process according to the present invention is carried out by a person or persons utilizing artisanal hand cooking techniques throughout the cooking process at intervals according to the following procedure:
1. Stoke open oven with wood (and/or alternative heat generating material(s) such as charcoal, coal, char, coke, natural gas, propane, and electric heat, or a combination thereof) in non-cooking area of oven until ambient temperature inside is at least 700° Fahrenheit;
2. Set cooking stand and cooking surface (either a slidable grill or a slidable and rotatable grill as shown, for example, in the figures) in the primary cooking area of oven deck (approximately back center of the oven deck);
3. Position and burn wood within or under the stand in the cooking area of deck until temperature at the cooking surface on the stand is greater than about 1000° Fahrenheit, preferably between 1000° and 1200° Fahrenheit;
4. With one end of the positioning handle and/or tongs removably attached to the front end of the cooking surface, slide the slidable cooking surface (or the slidable and rotatable cooking surface) out of the front of the stand;
5. Position food on the cooking surface, preferably toward the back half of the cooking surface;
6. Slide the cooking surface back into position on the stand using the positioning handle or tongs placing the food directly above the burning wood fire and searing the food;
7. Move, rotate, and/or reposition the cooking surface and/or also flip the food as desired by sliding the cooking surface forward using the positioning handle or tongs, manipulating the food, and then returning (sliding) the cooking surface back into the stand by pushing it towards the back of the stand and oven;
8. After the food is fire seared, the food can be removed from the oven and set to rest and/or the food can be cooked further according to the customer's requested cooking level on the cooking surface and/or elsewhere in the oven away from the direct flame such as, for example, a sizzle platter outside the primary cooking area.

Preferably, dried wood is the fuel source used in the cooking devices according to the invention because of the high temperatures needed and attainable with wood. Different wood varieties may additionally be used (e.g. hickory, mesquite) to impart added flavor to the foods (meats) while they are cooked. As previously described, alternative or additional fuel sources for the method according to the invention may also include charcoal, coal, char, coke, natural gas, propane, and electric heat, or a combination thereof.

The instance of cooking a steak by utilizing the means, methods, utensils and utilities underlying the present invention is unique to that of conventional methods and thus becomes a new reference standard. Under the present invention, a standardized process as the primus to cooking with a wood (and/or alternative fuel) fired heat source(s) at extremely high temperatures allows practitioners and consumers to know they are consuming foods from this process as different than other methods, having higher quality standards and satisfaction above that of other cooking methods. Therefore it is important to develop standardization techniques for cooking traditional food groups (meat; seafood; poultry, etc.) under a new and novel method and commercialize these processes for delivery to the broad market. The wood (and/or adjunctive heat source(s)) is/are burned in the oven directly beneath the cooking surface (slidable grill or slidable and rotatable grill), in the primary cooking area, thereby enabling the direct fire searing according to the invention in the primary cooking area.

Up until applicant's invention, there has not been any known standardized method or methods for cooking steak, beef, lamb, pork, veal and/or any other mammalian game, in an open brick oven or a hearth oven fabricated out of high temperature tolerant materials (e.g, brick, clay, stone, and high temperature resistant metals and alloys capable of withstanding the very high temperatures).

The present invention includes equipment and utensils including a cooking stand and a slidable (or slidable and rotatable) cooking surface as shown in the Figures as well as a positioning handle and/or tongs (the “Utilities and Utensils”). The Utilities and Utensils provide an effective and tactile means of safely placing the food stocks and provisions in and out of a Fire Source and the open oven according to the invention.

The propriety of the processes, Utilities and Utensils underlying the present invention centers around (i) an artisanal hand cooking process that requires performance steps incorporating heat, time and positioning of the food stocks and provisions that when articulated, does not ruin the food otherwise cooked without knowledge of the process described herein; and (ii) the architecture of the Utilities and Utensils which are unique, original, and born from a repetitive process in trial to bring a commercially viable end product for use in both utility (the Utilities and Utensils) and in the use for cooking to completion food stocks and provisions using fire searing methods.

Neither the design of the Utilities and Utensils nor the processes described herein have been used commercially to cook food stocks and provisions, specifically, steaks, beef, lamb, pork, veal and/or any other mammalian game in a hearth oven and directly into a Fire Source.

The present invention when used properly, results in certain food stocks becoming fire seared (“Fire Seared”) in the primary cooking area, and by finishing the cooking process by means and methods of cooking foods directly in and indirectly in and out of flames (fire).

The positioning of the fire source directly beneath the cooking surface (either slidable or slidable and rotatable) is an important means and method design which causes fire to envelope the food product being cooked. This causes a unique convection process born from the manipulation of the fire source, and food stocks and provisions by human and artisanal means.

The cooking process described includes searing, charing, maneuvering by hand and an artisanal convection process (“Artisanal Convection Cooking Process”) that places the food in contact with the flame for intervals and over a certain period of time.

The finished product is a meat, seafood or poultry product that is charred, seared with the natural flavors and juices trapped within the finished food, thus making the finished product, unique, and markedly improved over other competitive products cooked by all other conventional means and methods.

The heat created by this cooking process will reach temperatures higher than that created by conventional commercial and non-commercial heating devices for cooking food (i.e., commercial convection cooking ovens that reach temperatures of up to approximately 700° Fahrenheit.) The heat created in this Artisanal Convection Cooking Process preferably is greater than 700° Fahrenheit in the oven, most preferably greater than 1000° Fahrenheit in the primary cooking area.

Due to the configuration of an open oven including the depth and the intensity of the heat created within the cooking chamber, a conventional hand cooking method is problematic and dangerous. There is therefore a need for new equipment for applicant's cooking methods to be utilized in these types of ovens.

The present invention solves the problematic elements of hand cooking at high temperatures by virtue of steps and standardized processes which incorporate uniquely designed and proprietary cooking Utilities and Utensils.

The “Fire Searing” Utilities and Utensils are designed to reduce the dangers of hand cooking near the high temperature Fire Source; and improve the maneuverability associated with cooking certain food groups in a Fire Source and in an open oven, in a time dependent manner.

The present invention of method and means also incorporates fabrication and design of the “fire searing” Utilities and Utensils, including but not limited to a specialty design for a slidable (or slidable and rotatable) cooking surface made for the inside of an open oven fabricated with high temperature resistant metals and alloys. The cooking surface is preferably light and grill-like allowing for high permeation of fire through it to sear and char the foods being cooked upon it using direct flames.

### BRIEF DESCRIPTION OF THE DRAWINGS

FIG. 1 shows an example embodiment of the apparatus according to the invention with a cooking stand with rails for a slidably attachable cooking surface having a gripping block, a grill bar and a positioning handle/tongs.

FIG. 2 shows an example embodiment of cooking surface comprising an under mount locking pin, a positioning handle receiver, and a example positioning handle with a curved end. An alternate end on the positioning handle is shown along with an alternative front end of the cooking surface configured to receive the alternative positioning handle shape.

FIG. 3 another embodiment with a configuration for a circular cooking surface that is slidable and rotatable having a positioning handle/tongs.

FIGS. 4A-4D further show the rectangular and circular cooking surfaces shown in the prior Figures. FIG. 4A shows the open oven configuration and a cooking stand on the surface of the cooking oven.

### DETAILED DESCRIPTION OF THE INVENTION

Reference is being made in detail to presently preferred embodiments of the invention. Selective embodiments are provided by way of explanation of the invention, which is not intended to be limited thereto. In fact, those of ordinary skill in the art may appreciate upon reading the present specification and viewing the present drawings that various modifications and variations can be made.

The invention consists of a cooking stand 10, a removably attachable cooking surface 20 (slidable or slidable and rotatable), and a positioning handle or tongs 40. The invention may be retrofitted into existing open ovens (e.g. brick ovens or hearth ovens). Alternatively the invention is the improved open oven including the cooking stand and removable cooking surface (slidable or slidable and rotatable).

The cooking stand 10 is comprised of a high temperature rated frame 12 and legs 13. The dimensions of the stand, including its width, length and height, may vary according to the dimensions of the opening in the front of the open oven in which it is to be used. Preferably, the cooking stand 10 will have the largest dimension possible that allows it to be completely removed from the oven—that is, the stand 10 can pass through the front opening in the oven in which it is used. Removability allows for the cooking stand 10 to accommodate the largest possible cooking surface inside the oven with complete removability for ease of cleaning the oven (the cooking deck).

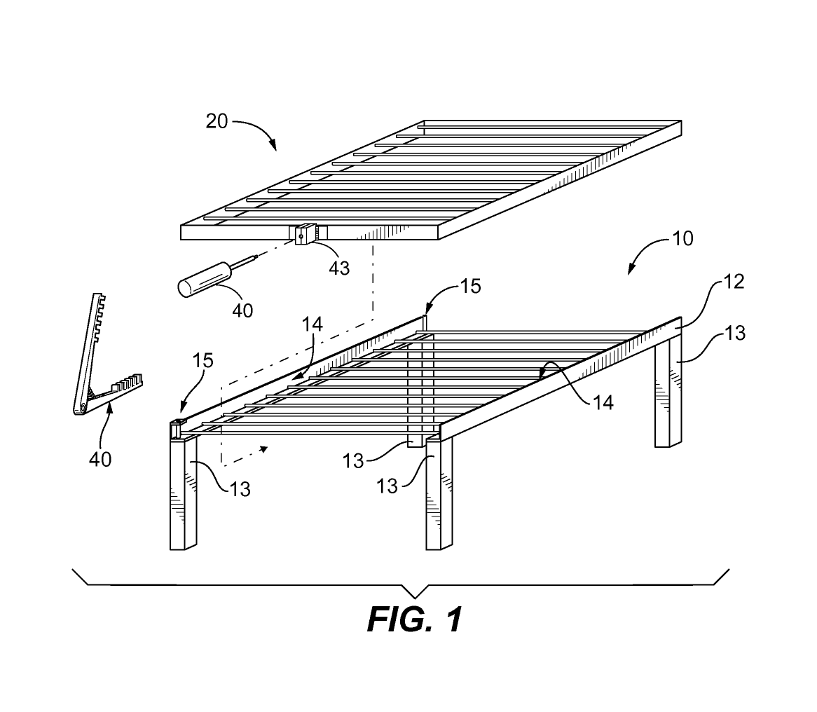

As shown in FIG. 1, the cooking stand's frame 12 consists of a front, a back, a right side, a left side, a top and a bottom. The frame 12 is preferably rectangular in shape, and includes an aperture or a plurality of aperture's passing through the frame 12 from top to bottom. The frame 12 may also be configured in other geometric shapes including, but not limited to, squares. The shape of the frame is most preferably complementary to that of the cooking surface. The frame includes rails/racks 14 positioned along and extending the depth of the frame 12, the length of the right and left sides of the frame 12 when viewed from the front of it. The rail/racks 14 are configured to support the cooking surface 20 inside the frame 12 and allow the cooking surface 20 to slide therein. The right and/or left sides of the frame, toward the front side of the frame, further include locking pin plates 15 and/or stopping blocks along the top of the frame 20. The locking pin plates and/or stopping blocks 15 are configured to contact locking pins positioned on the slidable cooking surface when the slidable cooking surface is at a fully extended position in the frame. Locking pin plates and locking pins 15 prevent the cooking surface from undesireably sliding out the front of the frame. Although the frame preferably includes two locking pin plates 15 for added safety, the frame may also be made to include a single locking pin plate 15 or no locking pin plates. The position of the locking pin plate(s) may also be varied on the frame.

The cooking stand is further comprised of legs 13 positioned along the bottom of the frame 12. The legs are preferably positioned at the corners of the cooking stand 10 to provide support and stability, although they may be secured to other locations on the frame 12 depending on the shape of the frame 12. The legs 13 may be square, rounded or various other shapes. The cooking stand legs 13 are preferably about six inches in height to allow space for a heat source (e.g. burning wood), to be positioned below the cooking surface 20 allowing contact between said heat source and the food and permitting the heat searing of foods that are positioned on the cooking surface 20. The legs 13 may additionally include fastening apertures at their bases allowing for the cooking stand to be removably or even permanently fastened/connected to the open oven's deck.

In other embodiments, the legs 13 may be made so as to be adjustable, allowing for the user to alter the height of the cooking stand 10. The adjustment may be accomplished using threaded, screw-type legs that may be threaded into complementary threaded apertures on the cooking stand's frame. This adjustability would allow for the cooking stand to be installed in open ovens having a shorter loading entry. The adjustable legs would additionally allow for the inventions user to change the distance between the oven deck and the cooking surface 20, and/or the cooking surface 20 and the heat source placed in the cooking stand 10.

The cooking stand 10 may be made from high temperature rated synthetic, composite and/or natural materials, including but not limited to stainless steel and cast iron. As referenced, it is preferred that the cooking stand 10 be fabricated from materials that can withstand the high temperatures specified (e.g. greater than 1000° Fahrenheit), materials that are safe for food, and that can be easily cleaned.

It is additionally preferred that the cooking stand 10 be slightly weighted, particularly towards its back end, so as to prevent the cooking stand 10 from tipping forward when the cooking surface is holding food and completely extended out of the frame 12. This may be accomplished using denser or thicker materials, or weights clamped to the undercarriage to construct the cooking stand 10, or by adding additional material or weight to the cooking stand 10. Alternatively, the cooking stand 10 may be fastened/secured to the deck of the open oven in which it is used by way of the fastening apertures on the cooking stand's legs 13. It is understood that the different components of the cooking stand may be constructed using the same material, or may be made from different materials.

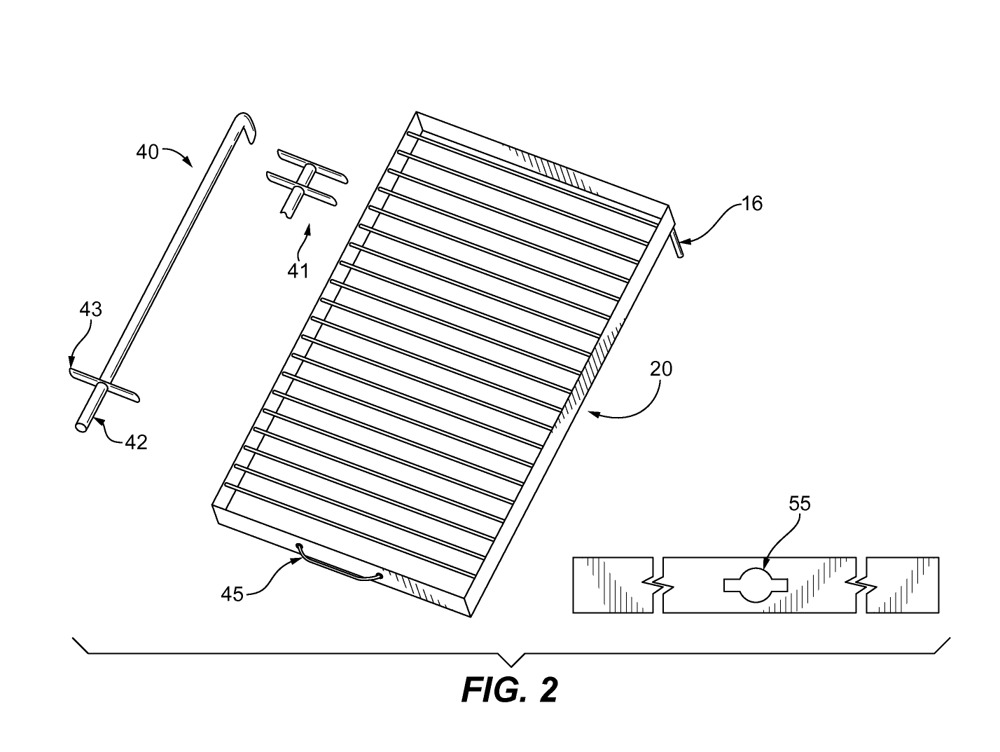

As shown in FIG. 1, the invention further consists of a slidable cooking surface 20. The slidable cooking surface 20 may be a grill, a surface with some perforations, or a combination of different cooking surfaces (e.g. slats, mesh, solid and/or perforated surfaces), allowing for the preparation of different foods using different cooking methods (e.g. grilling, frying). The invention may also include several different cooking surfaces that may be interchangeably used with the cooking stand 10 depending on the type of food that is to be prepared. The slidable cooking surface 20 is comprised of a top, a bottom, a right side, a left side, a front and a back. The geometric shape and dimensions of the cooking surface 20 may vary, although it is preferred that it be complementary to the cooking stand 12 so that the right and left sides of the cooking surface rest upon the cooking stand's rails/racks. The cooking surface 20, along its back side and extending upwards away from its top surface, may include one or more locking pins 16. The locking pin(s) 16 are configured to engage the locking pin plate(s) 15 of the cooking stand 10 when the cooking surface 20 is positioned upon the cooking stand's 10 sliding racks 14 and when it is in the fully extended position, pulled away from the cooking stand 10. The locking pins 16 are safety mechanisms that prevent the inadvertent removal of the cooking surface 20 from the cooking stand 10. In other embodiments of the invention, the locking pins 16 may be positioned along the back corners of the cooking surface 20, extending away from its bottom surface such as shown in FIG. 2. In this embodiment the locking pins 16 may be configured to have a block to bar mechanism or a nail type shape, so that the free end of the locking pins or blocks have a flat cap like top whose diameter is larger than that of the rest of the locking pin 16. Additional improvements may include that in which the locking pins 16 may engage a pin groove (not shown) positioned along almost the entire length of the cooking stand's sliding racks 14. The width of the pin groove along the majority of its length is slightly larger than the diameter of the locking pins 16. At the end of the pin groove towards the back of the cooking stand, the pin groove includes an aperture whose shape and diameter are complementary to that of the locking pin cap, so as to allow the locking pin 16 to engage and disengage the pin groove only at that location. The front of the cooking surface 20 may include a gripping block 43. The gripping block 43 comprises a front hinge to enable opening and affixing block to front of cooking surface 20. The gripping block shown in FIG. 1 is cube like in shape and has a bore hole configured to receive the end of the positioning handle 40.

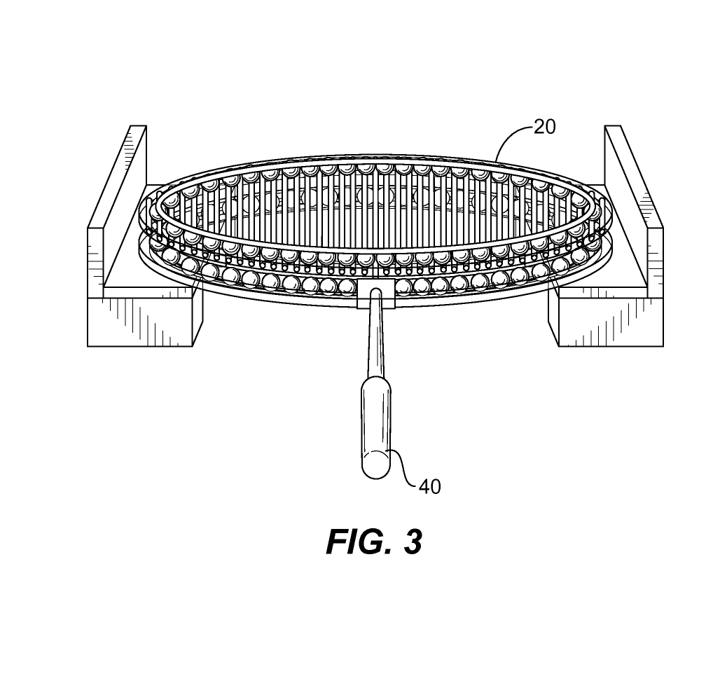

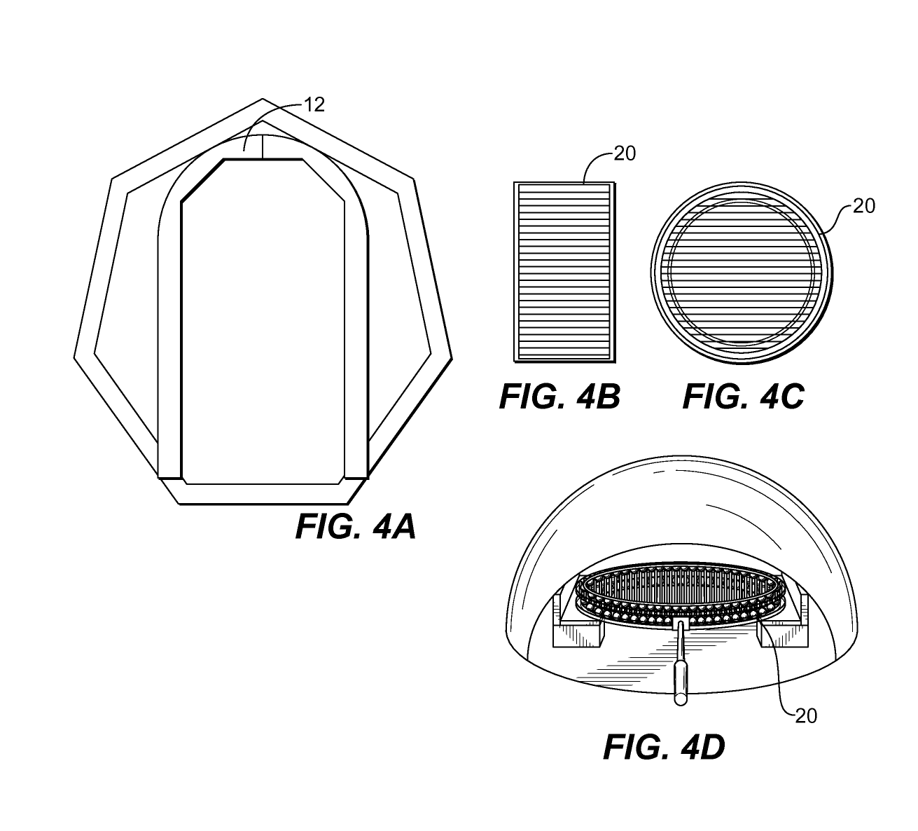

Another configuration for a cooking surface 20 is shown in FIGS. 3 and 4C and 4D. The cooking surface 20 is a circular cooking surface that is slidable and rotatable using ball bearings or the like. The cooking surface 20 has at least two to three contact points with the cooking stand frame 12 on the circle's diameter (preferably three equidistant perpendicular points along a 90° to 180° azimuth). Here again, the cooking surface 20, along its back side and extending upwards away from its top surface, may include one or more locking pins 16 configured to engage the locking pin plate(s) 15 of the cooking stand 10 when the slidable and rotatable cooking surface 20 is positioned upon the cooking stand's 10 sliding racks 14 and when it is in the fully extended position, pulled away from the cooking stand 10. The locking pins 16 are safety mechanisms that prevent the inadvertent removal of the cooking surface 20 from the cooking stand frame 12.

The cooking surface 20, along its front side, may include a cooking surface handle 30, hook or latch that can be removably attached to the end of the positioning handle or tongs 40. The cooking surface handle 40, among other configurations, may be a simple loop or a lock and key type aperture.

The cooking surface 20 is most preferably a grill-type configuration with slats (openings) between parts of the grill, although it is understood that the cooking surface 20 may include different configurations. The spacing of the slats may vary along the cooking surface 20 so as to be greater on one end than on the other. The area(s) of the cooking surface 20 having slats positioned closer together allow for the user to cook foods which are smaller and/or more delicate, such as fish, poultry or vegetables, without the foods breaking apart or falling through the slats/spaces while cooking. The other area(s) of the cooking surface 20, where the spacing is larger, is more appropriately configured for the preparation of larger foods, including, for example steaks, chops, or ribs. The cooking surface 20 can also be made so that the slat spacing is uniform from one end to the other. The cooking surface 20, instead of having long slats, could be configured in a mesh-type configuration. Likewise, the mesh size can be varied on different areas of the cooking surface.

The cooking surface 20 may be made from high temperature rated synthetic, composite and/or natural materials, including but not limited to stainless steel and cast iron. It is preferred that the cooking surface be fabricated from materials that can withstand the high temperatures specified (e.g. greater than 1000° Fahrenheit), materials that are safe for food, and that can be easily cleaned.

The invention further consists of a positioning handle or tongs 40. The positioning handle is used to adjust the positioning of the cooking surface 20 about the cooking stand 10 by sliding the cooking surface 20 along the cooking stand's sliding racks 14. The positioning handle 40 may be a rod like tool having a front end and a back end. The positioning handle 40 may be telescoping or the length of the positioning handle may vary according to the depth of the open oven in which the invention is being used, or according to preference. It is preferred that the positioning handle is configured so as to allow a user to manipulate the positioning of the cooking surface 20 using the positioning handle 40, without having to place the user's hand(s) inside the oven thereby limiting the user's exposure to the heat and flames in the oven.

At the front end of the positioning handle 40 is a hook type structure configured to removably secure the positioning handle 20 to the cooking surface handle 45 as shown in FIG. 2. This may be done by passing the front end of the positioning handle 40 through the cooking surface handle 45 and pulling/sliding the cooking surface 20 out of the frame 12 of the cooking stand 10, or pushing the front end of the positioning handle 40 against the front of the cooking surface 20 to slide the cooking surface 20 into the frame 12 of the cooking stand 10. In other embodiments, the cooking surface 20 may include an aperture 55 along its front end (as shown in FIG. 2) that is configured to removably engage the front end of the positioning handle 40, much like a lock and key, allowing the user to push and pull the cooking surface 20 along the cooking stand's sliding racks 14. In this embodiment the front end of the positioning handle 40 may include fan like protrusions 41. The front end of the positioning handle 40 would be inserted into the locking aperture 55 of the cooking surface 20 so that the complementary shapes 41 of the positioning handle 40 and aperture 55 are likely oriented. Once the front end of the positioning handle 40 enters the locking aperture 55, the positioning handle 40 can be slightly rotated so that the positioning handle 40 cannot be removed from the locking aperture 55 until it is rotated to its original position. The back end of the positioning handle 40 includes a handle 42 structure for the user to grasp the positioning handle 40. The handle 42 may be flat or contoured to the shape of a user's hand. The top of the handle 42 section may also include a shield 43 to further protect the user's hand while the positioning handle 40 is in use.

Alternatively, as shown in the Figures, a positioning tong 40 can be used. The positioning tongs 40 are preferably spring loaded requiring the user to push the two sides together to close them. The “teeth” at the ends of the positioning tongs can be used to grasp the cooking surface.

The positioning handle/positioning tongs 40 may be made using a variety of natural or high temperature rated synthetic, composite materials. It is preferred that the handle 42 be made from any material that is extremely heat resistant and retardant and which allows the handle 42 to maintain a temperature that allows its user to safely grasp the handle 42 even after prolonged use of the positioning handle 40 above and in open flames. The remainder of the positioning handle 40 may be fabricated using a variety of synthetic or natural materials, including but not limited to stainless steel, and cast iron. It is preferred that it be fabricated from materials that can withstand high temperatures (greater than 1000° Fahrenheit) and that can be easily cleaned.

The invention is also an improved open oven. The improved open oven is comprised of an internal cooking chamber having an about flat deck and an about domed ceiling. The about domed shape of the cooking chamber allows for a convection type flow of heat and air throughout the cooking chamber. The inside of the cooking chamber is accessed through an opening preferably located towards the front of the oven. The opening is in a half circle type configuration with a flat base and arched top. The dimensions of the oven opening are complementary to those of the cooking stand used within the oven allowing the cooking stand to be easily placed within and removed from the oven. The oven opening must likewise be large enough to allow its user to load a fuel source, (e.g. wood, coal, etc) into the cooking chamber and to clean out any debris (e.g. ash, unburned fuel) when necessary. The oven opening may be configured to receive a removable door that closes the opening. The oven opening may be configured to receive a removable door that does not completely close the opening, but instead reduced the opening size to minimize heat loss during use. The oven may include one or more removable door(s) allowing the user to access the cooking chamber. The door(s) may be removably securable to the oven.

Directly above the opening in the front of the oven is a hood and chimney for the evacuation of smoke and heat. The hood may be powered using a fan/blower. The cooking chamber, along its farthest right or left side includes a fuel region dedicated to igniting and storing a burning heat source, such as wood, coal, etc. The oven may include a heat source grate built into the deck or placed above it on which the burning heat source may be placed, allowing the burning heat source to be oxygenated from above and below. The fuel region may additionally include a heat resistant fan used to provide a more consistent flow of air to the burning heat source to ensure that it continues to burn. The fan may simply push air from within the cooking chamber towards the burning heat source, or it may be connected to a vent passing to the exterior of the oven so as to draw fresh air into the cooking chamber. The fan has the added benefit of promoting the convection style flow of heat throughout the cooking chamber, allowing for higher cooking temperatures to be achieved within the oven.

The fuel region may additionally include a lighting mechanism that can be used to initially light the heat source and/or to more easily maintain the ambient temperature of the cooking chamber while the oven is in use. The lighting mechanism may be run using natural gas and/or electricity, although natural gas is the preferred fuel. The lighting mechanism may be controlled by a thermostat that can be operated from the ovens exterior, either manually or automatically. The thermostat may be connected to sensors that take temperate readings at different areas of the cooking chamber, including the temperature directly at the oven's non-elevated, flat cooking surface (the primary cooking area) and the overall ambient temperature within the cooking chamber itself. The temperature readings may be monitored using gauges positioned on the outside of the oven or through the thermostat. The thermostat may be set to maintain a minimum and maximum temperature within the oven so that the lighting mechanism automatically ignites and turns off if the heat produced by the burning heat source goes above or falls below what is desired to maintain the oven's temperature. The cooking chamber, on the side opposite the fuel region, includes an auxiliary cooking area (secondary cooking area). The auxiliary cooking area is used to cook foods that require less heat, to complete the cooking of foods that have been partially cooked on the oven's non-elevated, flat cooking surface, or simply to keep foods warm. The auxiliary cooking area is preferably large enough to accommodate sizzle platters and pans typically used during the preparation of foods.

The cooking chamber, along the back center region of its deck further includes an ash drainage grill built directly into and positioned to be about flush with the oven's deck. The ash drainage grill is configured for the direct placement of a burning fuel source upon its non-elevated, flat cooking surface. The ash drainage grill covers a chute that leads to a debris tray located beneath the oven deck. The debris tray is positioned below the oven's loading entry and is removably accessible to allow a user to clean out any ash, debris and runoff that falls through the ash drainage grill. The ash drainage grill captures and directs any ash, debris and runoff from the burning fuel source and cooking food above it into the debris tray. The ash drainage grill and the open area directly below it (the chute) additionally serve to provide added oxygen to the burning fuel source placed on the ash drainage grill. The added oxygen that passes up from the chute allows the burning fuel source on the ash drainage grill to burn hotter and maintains a higher cooking temperature at the oven's cooking surface. The ash drainage grill also allows a user to maintain a cleaner oven deck throughout the cooking process and further facilitates maintenance of the oven by eliminating any excess debris or runoff from food in the oven that may cause unwanted flare-ups during cooking.

Directly above the ash drainage grill of the improved open oven is the cooking stand described above. The cooking stand may be positioned to simply rest upon the oven's deck, or it may be removably secured to the deck using locking means installed on the deck that are complementarily configured to the leg apertures of the cooking stand. The deck locking means may include nut, bolts, pins, or any other mechanism that would allow for the cooking stand to be removably secured to the deck. The cooking stand supports the cooking surface previously described above. The position of the cooking surface upon the cooking stand is manipulated using the positioning handle or positioning tongs described above. The cooking stand is positioned so as to allow any debris, and runoff from the foods being cooked on the cooking surface to fall on the burning fuel source positioned directly below it, causing the juices to vaporize and rise upward towards the cooking surface, thereby adding flavor to the food being cooked thereupon. Any excess juices and debris may fall past the burning fuel source, through the ash drainage grill and enter the debris tray.

The improved open oven may additionally include a heat resistant light(s) within its cooking chamber to allow its user greater visibility when the oven is in use or being cleaned.

The improved oven may also include a compartment for storing unburned fuel (e.g. wood), and for storing the additional cooking surfaces, doors and/or positioning handle. The improved open oven may be fabricated out of high temperature tolerant materials including but not limited to brick, clay, stone, and high temperature resistant metals and alloys capable of withstanding high temperatures.

### METHOD OF USING THE INVENTION

The cooking method and the use of the invention will be described. It is understood that the cooking stand, cooking surface (slidable or slidable and rotatable) and positioning handle/positioning tongs may be used separate and apart from the improved open oven by retrofitting them within an existing open oven, such as for example a brick oven or a hearth oven.

A cook would begin by first loading the open oven with a fuel source, preferably wood to bring the oven chamber temperature up to at least 700° Fahrenheit. The cooking stand is installed in the primary cooking area of the deck in the cooking chamber of the oven. The cooking surface must be slid into the cooking frame at an angle so that the locking pins of the cooking surface may bypass the cooking stand's locking pin plates. Although, depending on the size of the oven's cooking chamber and front opening, the cooking stand and cooking surface may be assembled in the oven, it is easier to do so outside the oven.

The cooking stand is positioned in about the middle of the deck, about centrally on the oven's deck towards the back region of the deck, where the ambient temperatures of the oven are higher. In those ovens with an ash drainage grill, the stand is positioned above the grill. The cooking stand may then be secured to the oven deck using the leg apertures and complementary locking means positioned on the deck. Once the cooking stand is in place, the cook would then ignite wood placed on the deck under the stand until a temperature of approximately 1000 degrees Fahrenheit is reached at the cooking surface. Once the cooking surface has been properly heated and has reached the desired temperature, the cooking surface is pulled out toward the front opening in the oven using the positioning handle and the cooking stand handle. Food is placed on the cooking surface and the cooking surface is pushed back into the frame of the cooking stand putting the food in direct contact with the fire beneath the cooking stand.

Cooking food requires a certain level of skill and attention that is mastered through training and experience. The positioning and orientation of food must constantly be manipulated throughout the cooking process to avoid burning. Throughout the cooking process the cook should monitor both the ambient temperature of the oven chamber and the temperature at the cooking surface, and add wood to maintain the at least 700 degrees and at least 1000 degrees.

One of the major benefits of the improved open oven and new cooking method is that the food cooks due to the extremely high ambient temperature within the oven chamber while the side of the food facing down on the cooking surface is being flame seared. Unlike conventional barbeque grills, the improved oven is essentially cooking both sides of the food at the same time, thereby reducing overall cooking times and ensuring that the maximum amount of moisture and flavor is retained, thereby resulting in a juicier, more desirable end product.

During the cooking process, the cook periodically flips and repositions the food. As the food cooks, juices and other runoff passes through the slats of the cooking surface and falls on the burning wood below and also into the ash draining grill if present. Some of the runoff that comes into contact with the burning wood will vaporize due to the high temperatures and rise back up towards the food. The excess runoff from the burning wood directly below the cooking surface will fall through the ash drainage grill, if present, pass through the chute and fall into the debris tray.

Depending on how the food is to be cooked, once seared the cook can either leave the food on the cooking surface in direct contact with flames (in the primary cooking area) or place the food off to the side of the oven on a sizzling platter in the oven's auxiliary cooking area until they reach their final desired consistency. The sizzling platter may be positioned by hand, using the positioning handle, or other utensils.

For purposes of safety, it is preferred that a utensil and/or tool be used to reposition anything inside the cooking chamber to prevent injury due to the high temperatures.

The cook may occasionally check the internal temperatures of the food using a thermometer. Once cooked to the desired level, the food is removed from the oven.

Occasionally, while cooking, or between uses, the oven is cleaned.

I claim:

1. A method for cooking in an open oven comprising:
stoking the open oven with in non-cooking area of oven until the ambient temperature inside the oven is at least 700° Fahrenheit;
burn wood beneath a stand with a slidable cooking surface located in a primary cooking area of the oven deck until the temperature at the cooking surface on the stand is greater than about 1000° Fahrenheit;
slide the slidable cooking surface out of the front of the stand;
position food on the slidable cooking surface;
slide the cooking surface back into position on the stand placing the food directly above the burning wood fire and in the flames;
reposition the cooking surface and flip the food using the sliding cooking surface forward to slide the food out of and back into the oven until the food is fire seared; and
removing the food from the oven;
wherein, the food is direct cooked and seared at a temperature of at least 1000 degrees Fahrenheit in an open oven.

2. The method according to claim 1 further comprising placing the food elsewhere in the oven away from the direct flame for indirect cooking for further cooking before removing the food from the oven.

3. The method according to claim 1 further comprising placing the food on a sizzle platter.

4. A removable cooking stand configured for placement inside an open oven comprising:
a frame with legs, said frame comprising locking pins and sliding racks along opposing sides of the frame for slidably receiving a removable cooking surface, said frame further comprising an aperture through the frame;
a removably attachable cooking surface slidably connected to said frame, said cooking surface having a grill type configuration with slats and locking pin plates to maintain the cooking stand in said frame; and
a positioning handle or tongs 40.

5. The removable cooking stand according to claim 4 wherein said removable cooking surface further comprises ball bearings and a rotatable grill top.

6. The removable cooking stand according to claim 5 wherein said removable cooking surface further comprises a cooking surface handle configured to removably attach to an end of the positioning handle.

7. The removable cooking stand according to claim 6 wherein said removable cooking surface is configured in a circular shape.

8. The removable cooking stand according to claim 7 wherein said removable cooking surface and said frame are stainless steel.

9. The removable cooking stand according to claim 7 wherein said removable cooking surface and said frame are cast iron.

10. The removable cooking stand according to claim 7 wherein said positioning handle comprises a shield to protect the user's hand while in use.
